(19) United States
(12) Patent Application Publication
(10) Pub. No.: US 2005/0098597 A1
(43) Pub. Date: May 12, 2005

(54) Precision dive gear-strong cottrell-scuba buoyancy compensator system

(76) Inventors: Joshua Silas Cottrell, Sherman Oaks, CA (US); William Edmund Strong, (US)

Correspondence Address: Joshua Silas Cottrell, 4728 Noble Ave, Sherman Oaks, CA, 91403, US

(21) Appl. No.: 10/982,735

(22) Filed: Nov. 5, 2004

Related U.S. Application Data
(60) Provisional application No. 60/517,831, filed on Nov. 6, 2003.

(51) Int. Cl. G08B 5/00; A45F 3/02

(52) U.S. Cl. 224/620; 224/629

(57) ABSTRACT

The Precision Dive Gear Strong Cottrell SCUBA Buoyancy Compensating System is a product that will forever change the SCUBA community. The system supports SCUBA (Self Contained Underwater Breathing Apparatus) equipment with the use of semi rigid shoulder hooks and rigid back plate (see DWG 25/27) keeping the chest area clear of straps. The system allows users to don and remove SCUBA equipment with speed and ease not found in current industry products. In emergency situations, the equipment can be removed in a fraction of the time that conventional equipment can take. The system is comprised of rigid shoulder hooks, rigid back plate, shoulder pads, back plate pads, waist belt, ballast weight pockets and optional crotch strap. The system is adjustable for a wide range of male and female users. The Back Plate is designed to accommodate single and double tanks and a wide range of equipment and accessories.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

It is our intention to claim the benefit of the provisional patent as follows.

application Ser. No. 60/517,831

Filling Date Nov. 11, 2004

Confirmation Number 8634

### CROSS REFERENCE TO RELATED APPLICATIONS

Not Applicable

### STATEMENT REGARDING FEDERALLY SPONSORED RESEARCH OR DEVELOPMENT

Not Applicable

### SEQUENCE LISTING

Not Applicable

### BACKGROUND OF THE INVENTION

The Precision Dive Gear—Strong Cottrell—SCUBA Buoyancy Compensator System (hereon in referred to as the SC System) was developed out of necessity and lack of any comparable product in the marketplace. An accident in the SCUBA community sparked the development of this product. A Technical SCUBA diver stepped off a dive vessel without turning on his air supply. Due to the amount of required equipment the diver had donned for the technical activities planned and the current manner in which it was attached to the diver, he could not remove his gear in time, resulting in a death by drowning.

A product that is quick and easy to remove in the event of an emergency is needed. The current webbing based systems require many interlocking straps to be secured around the torso of the diver to support the equipment. The goal is to remove the majority of these straps while still safely supporting the same amount of equipment.

A product is needed for female divers that does not compress their breasts. Current dive harnesses compress the breasts of a female divers making them uncomfortable.

### BRIEF SUMMARY OF THE INVENTION

The SC System allows a diver to don and ditch their equipment much safer, easier and quicker that any other system on the market today. The system utilizes two ergonomically contoured rigid hooks in conjunction with a rigid back plate to comfortably support the weight of the equipment on the diver's shoulders. Replacing the current webbing chest straps with these hooks allows the diver to breathe without restriction, therefore, reducing stress and increasing bottom time. The design allows the hooks to be horizontally adjusted for a wide range of different sized divers. Custom tailored padding ensures that the weight of the equipment is evenly dispersed over the shoulders of the user. Ample slots, holes and D-rings have been provided to attach a wide range of equipment. The combination of a waist belt and crotch strap (optional) are used in conjunction with the hooks and back plate to secure the system to the diver's torso while in and out of the water. Back pads have been designed to allow the user complete access to all of the attachment points on the back plate without removal. The system can be worn on the back or chest of the user, providing a wide range of flexibility in advanced situations. Equipment, such as computers, regulators and gauges, are firmly supported by D-rings at the end of each hook making donning trouble-free. The weight pocket system is fully supported by the back plate making the system more comfortable. The combination of the above invention and associated existing product improvements will make SCUBA diving safer, more comfortable and more appealing to a wide range of individuals.

### BRIEF DESCRIPTION OF THE DRAWINGS

Drawing 1/27—Back Plate elevation (FIG. 1), Back Plate section (FIG. 2)

FIG. 1 shows the Back Plate, the central component of the system. The Back Plate is a rectangular piece of 11 Gauge (0.125) 304 Stainless Steel with 1.5 inch dia. radius corners. The plate has many punched holes and slots of different sizes to facilitate the attachment of the hooks, straps, pads and accessories. Additional holes have also been placed in the plate to remove some weight.

FIG. 2 shows a section of the Back Plate. The middle of the plate has a “hat channel” formed into it. This channel provides additional rigidity and a pocket for the hardware used to secure dual tanks to the plate. This pocket protects the divers back from the associated hardware.

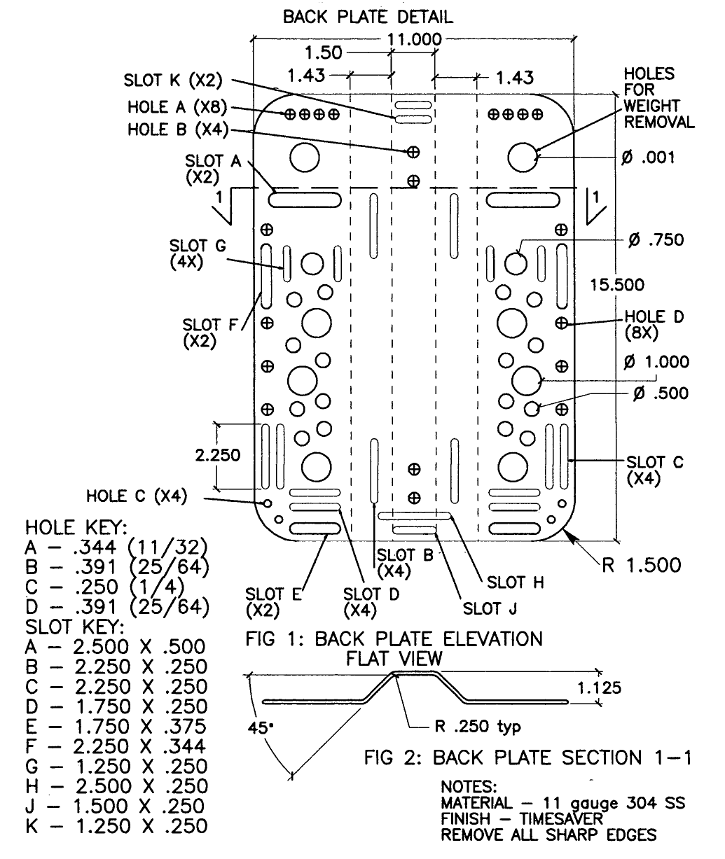

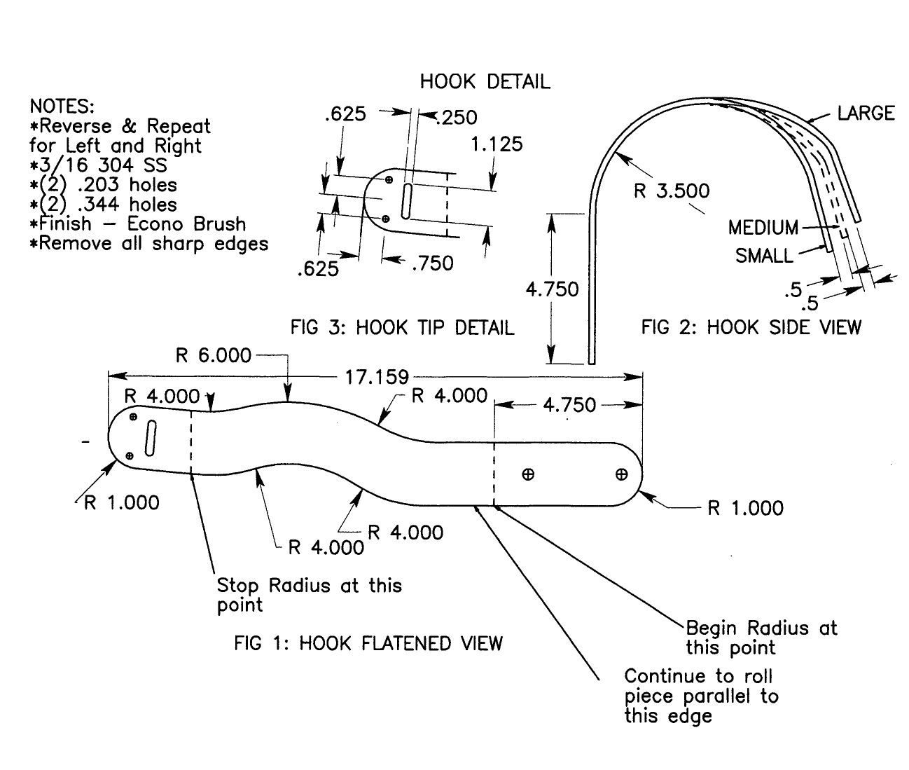

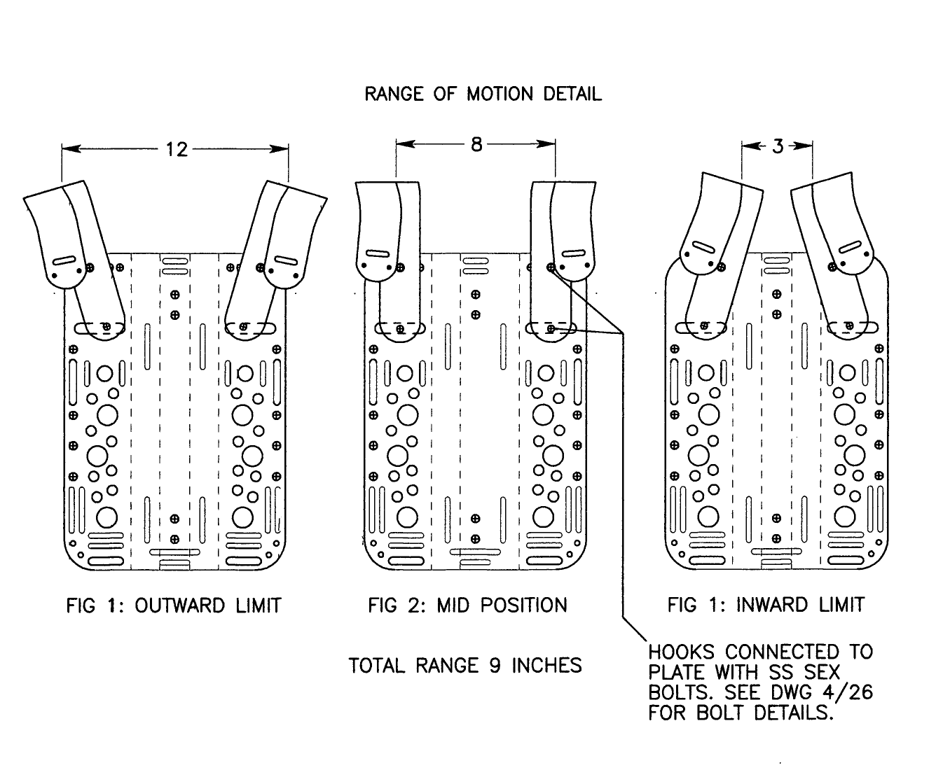

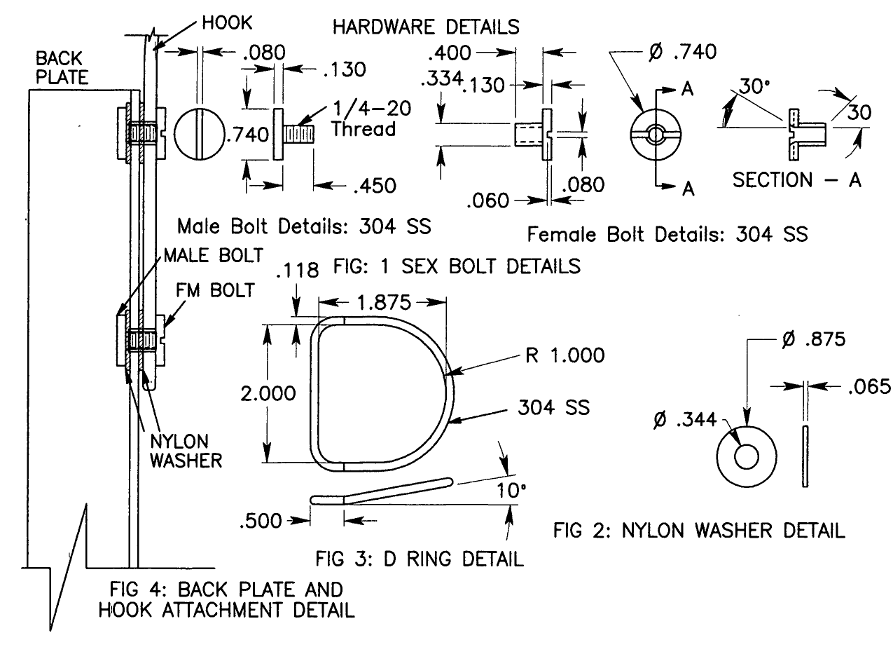

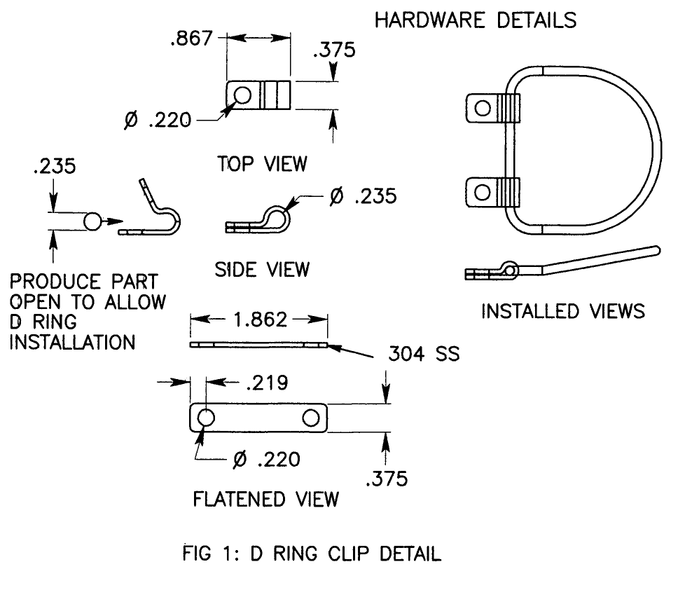

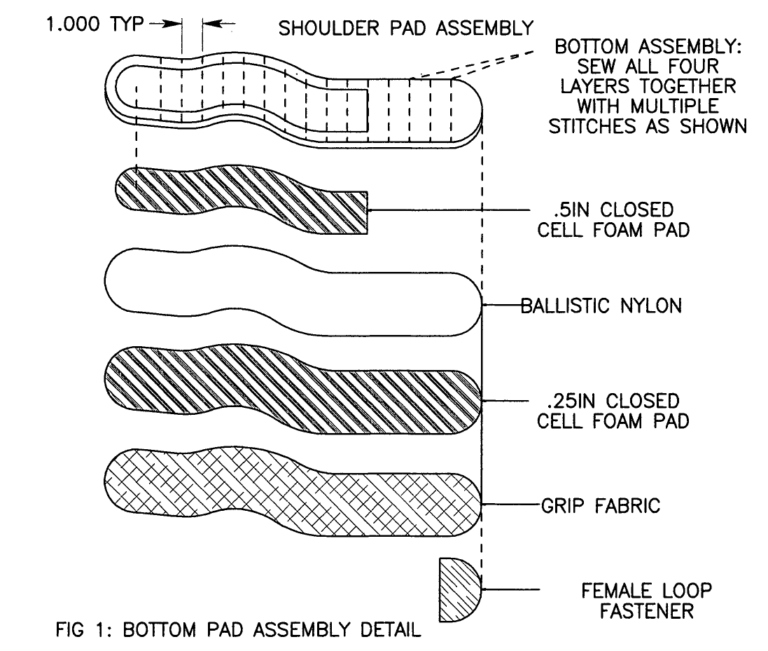

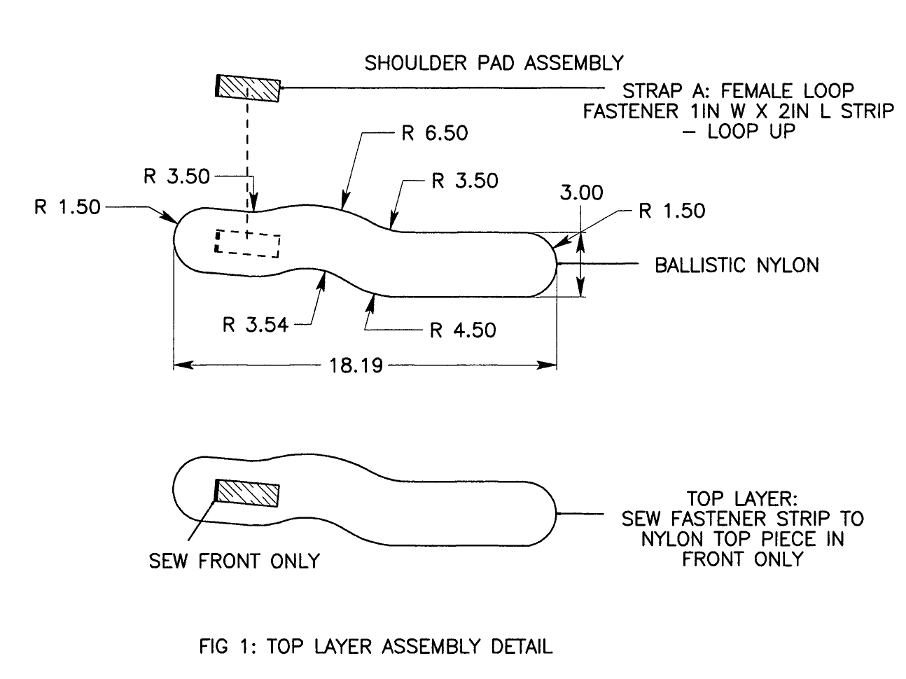

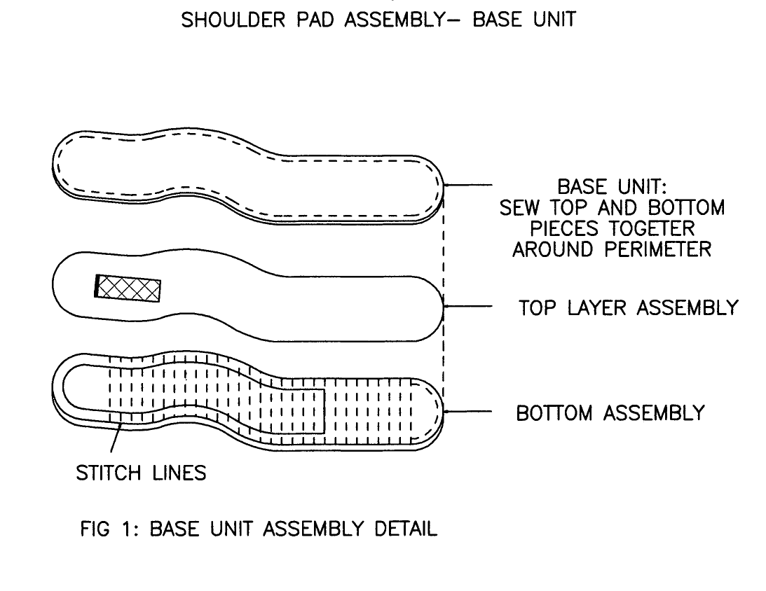

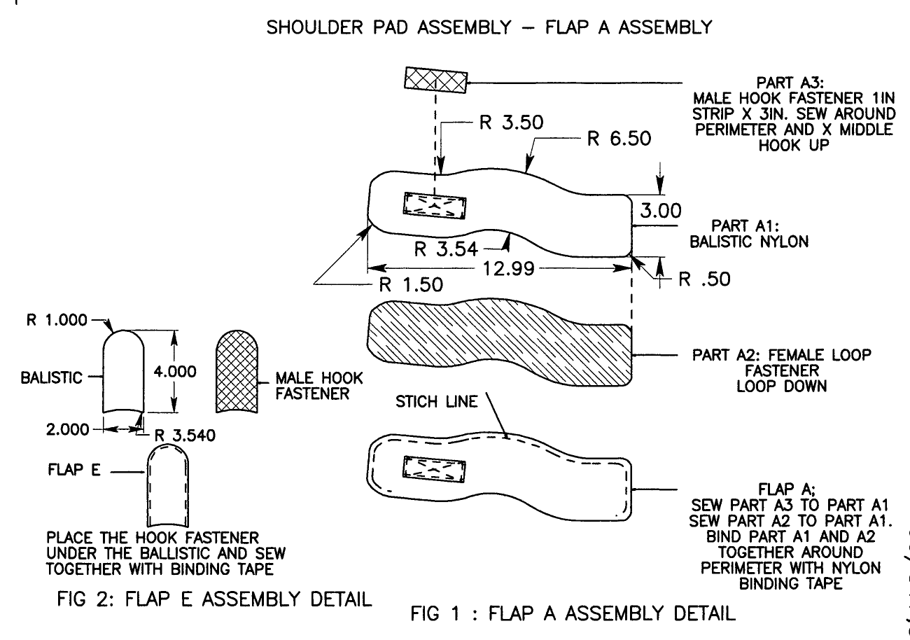

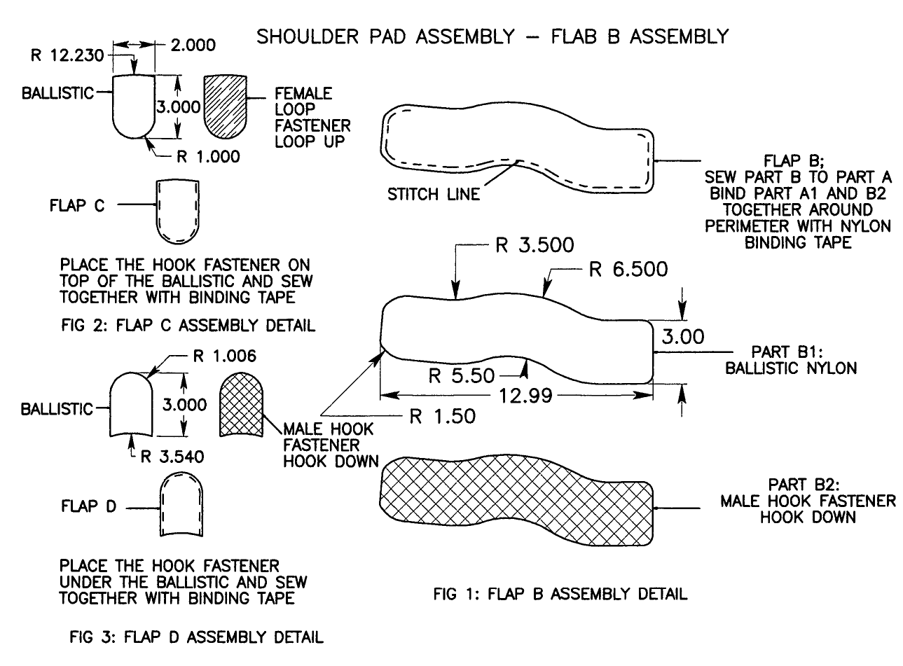

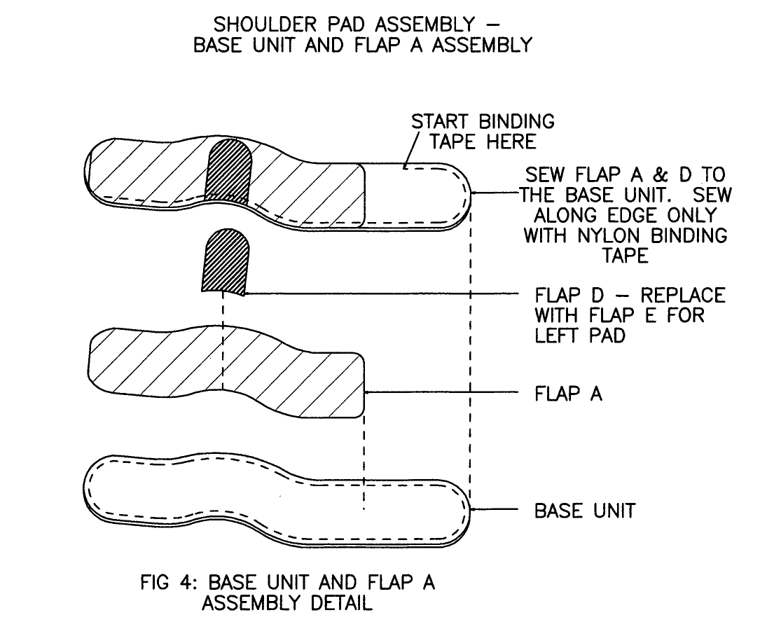

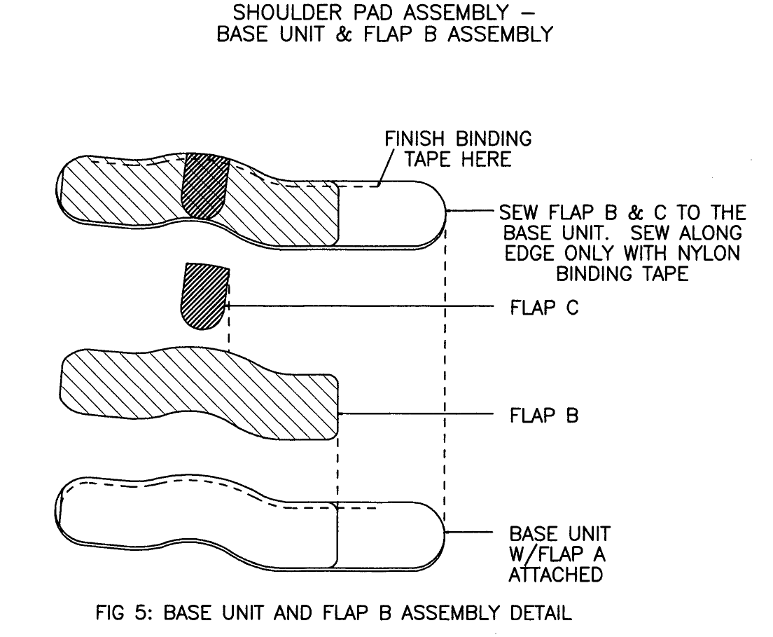

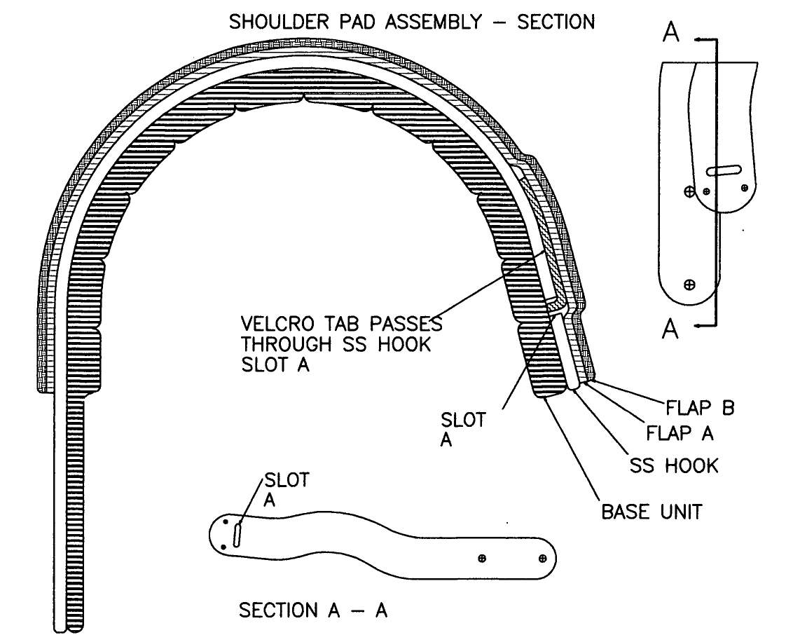

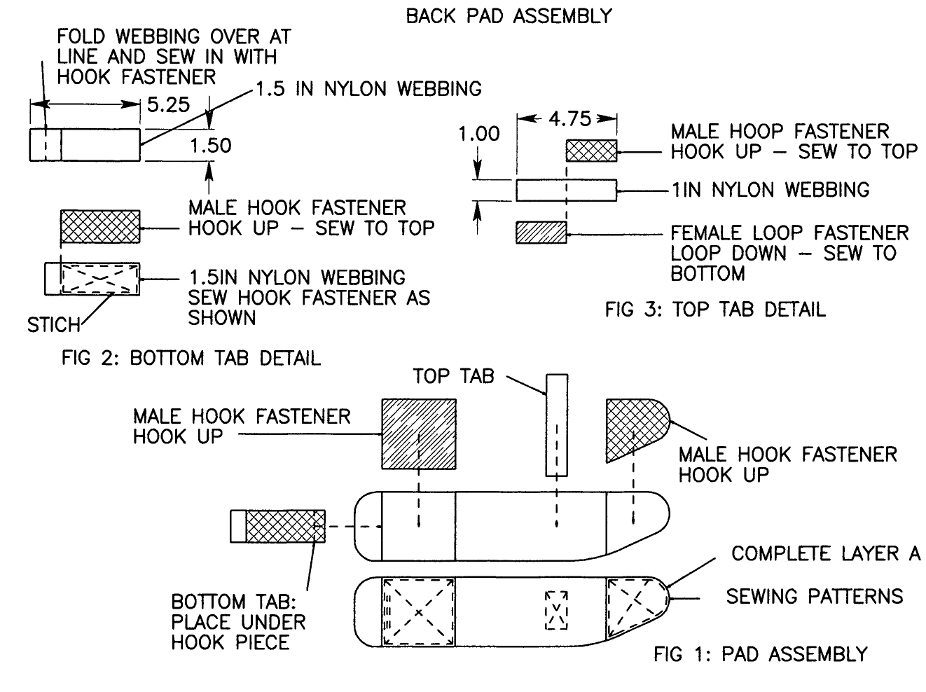

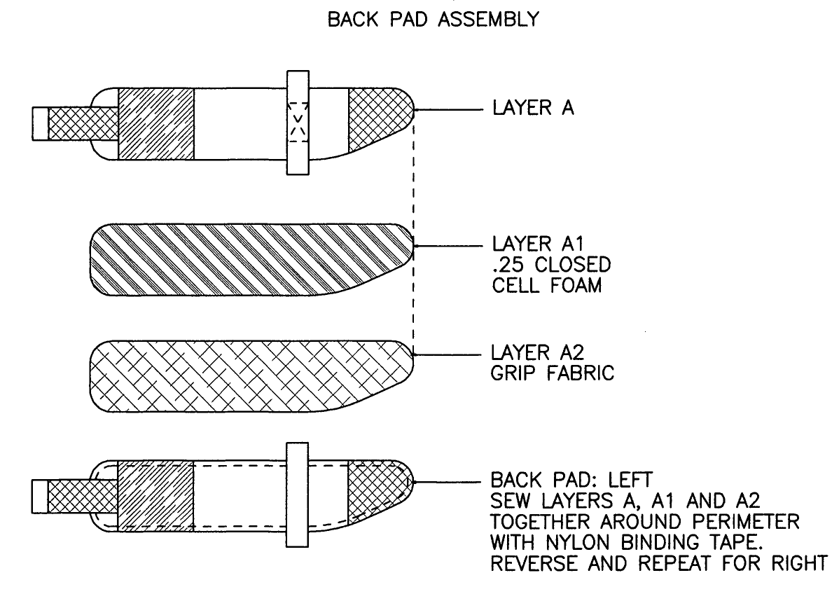

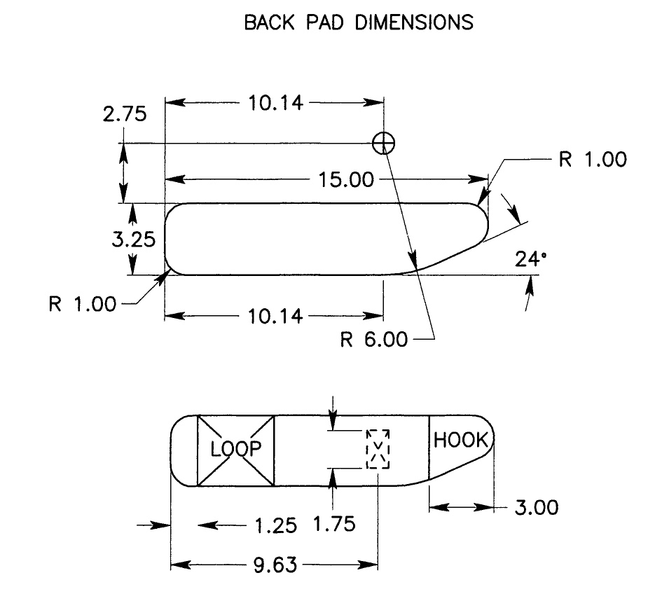

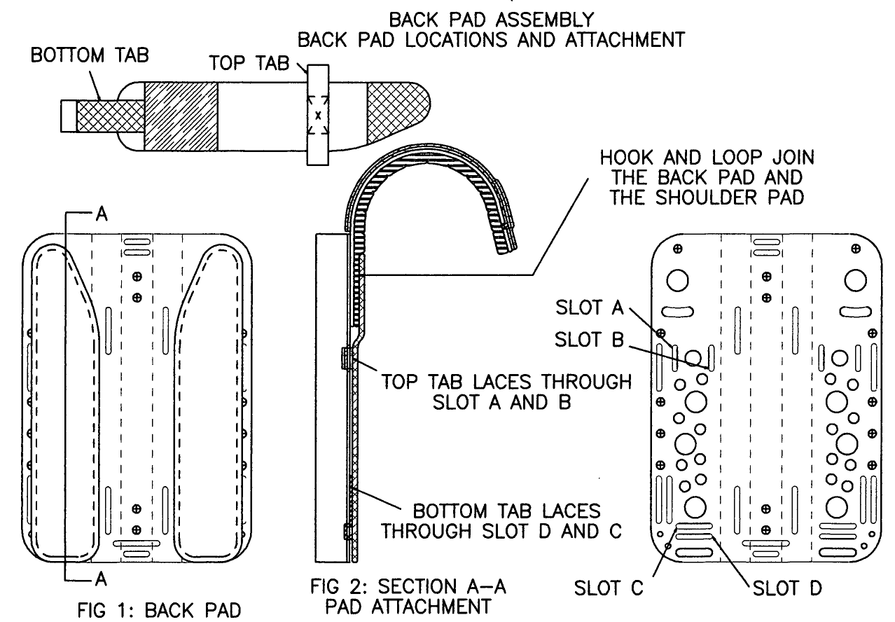

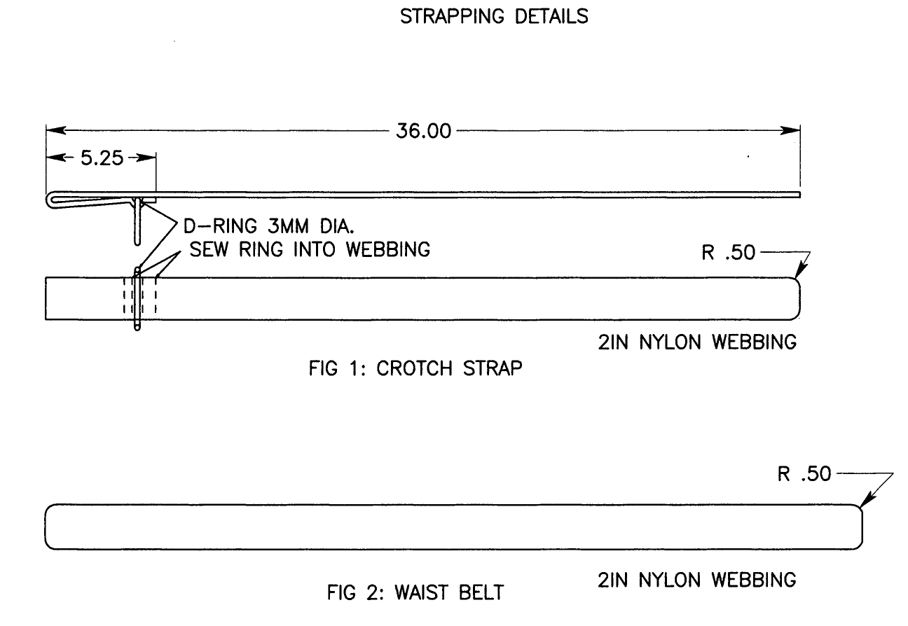

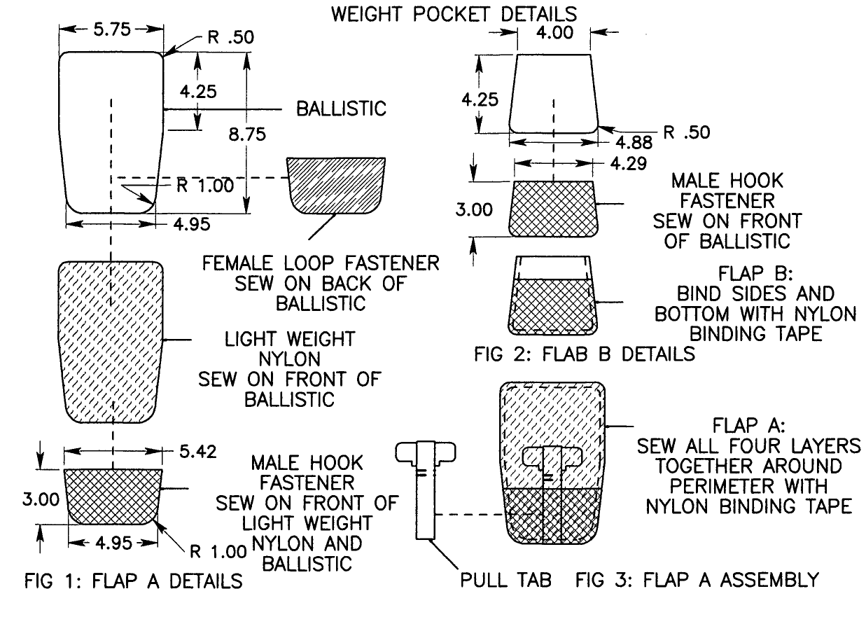

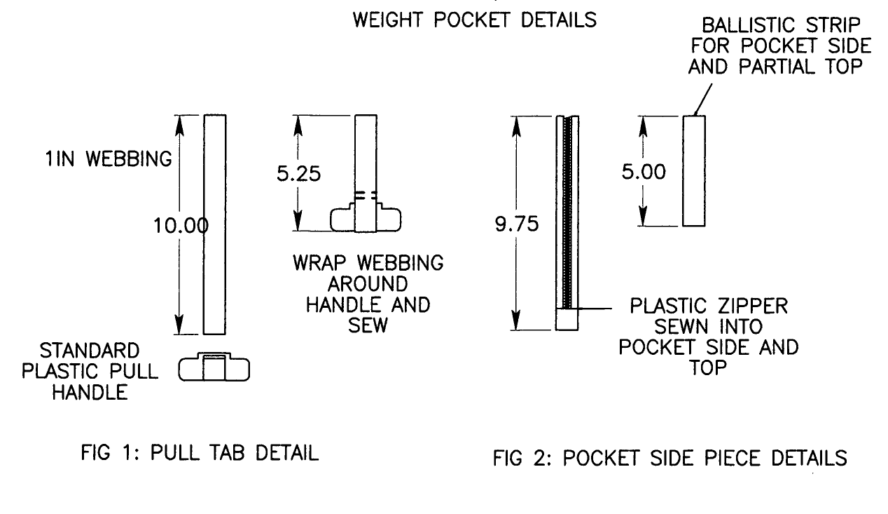

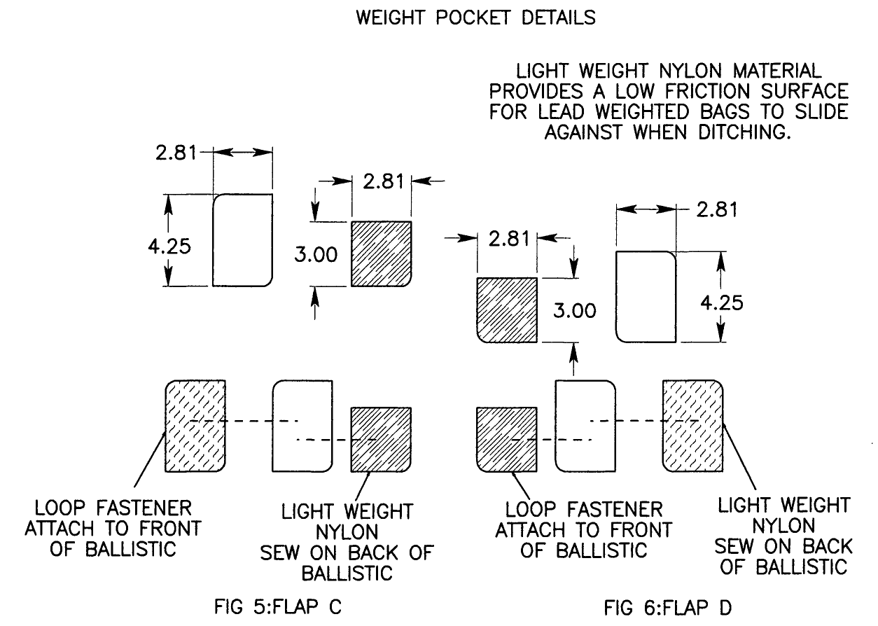

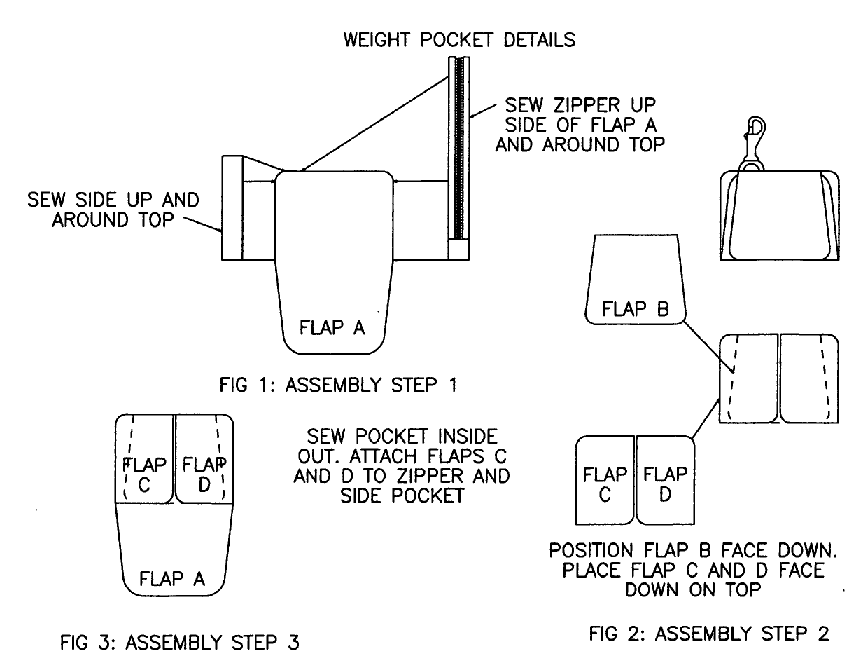

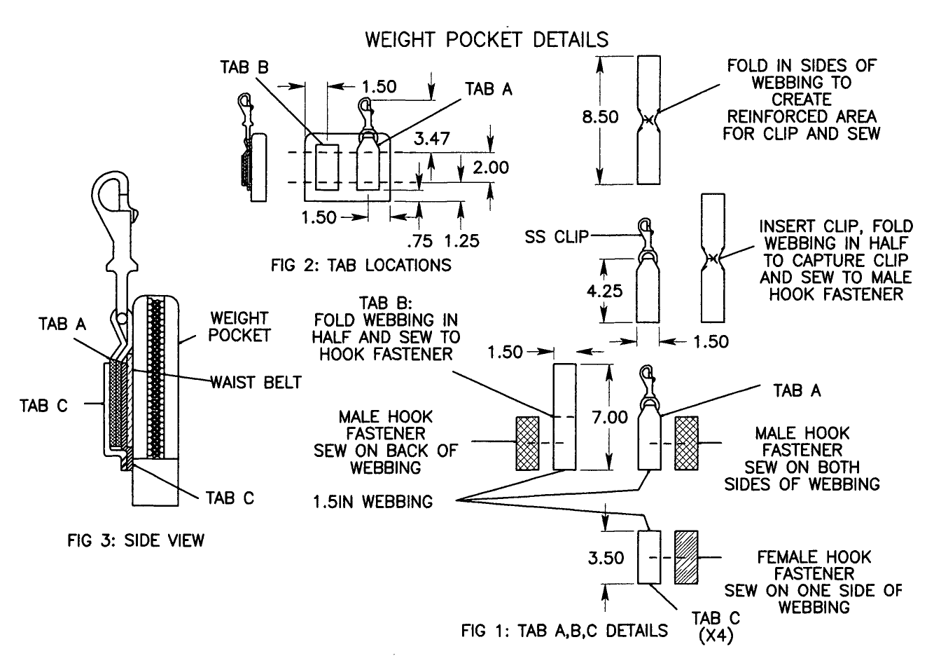

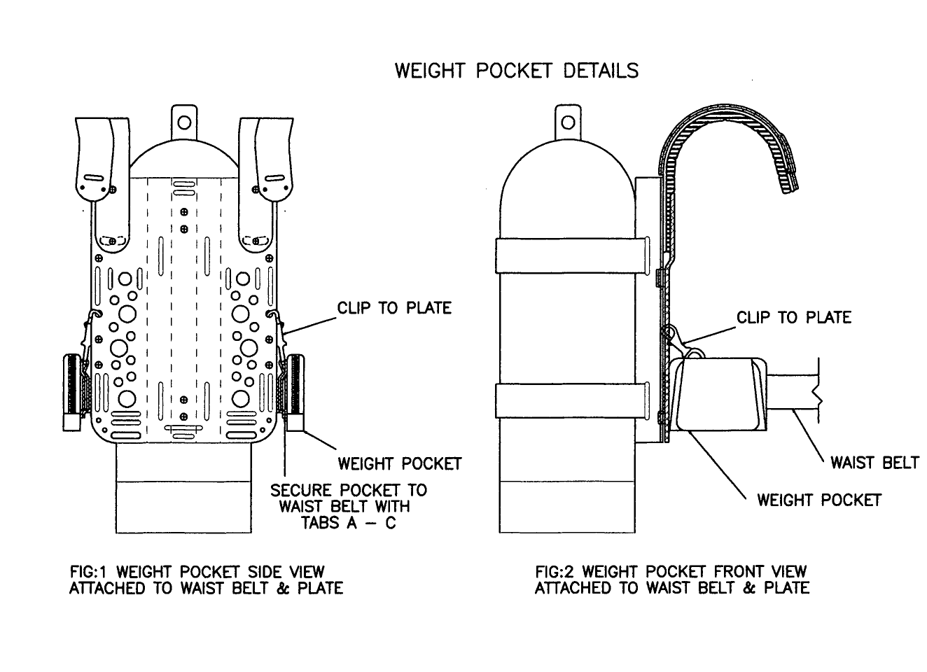

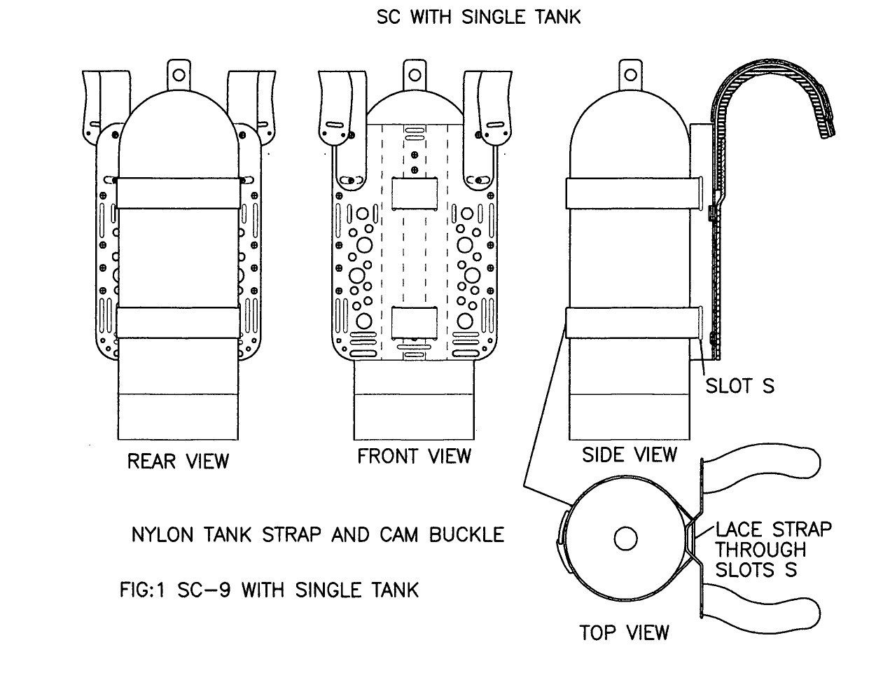

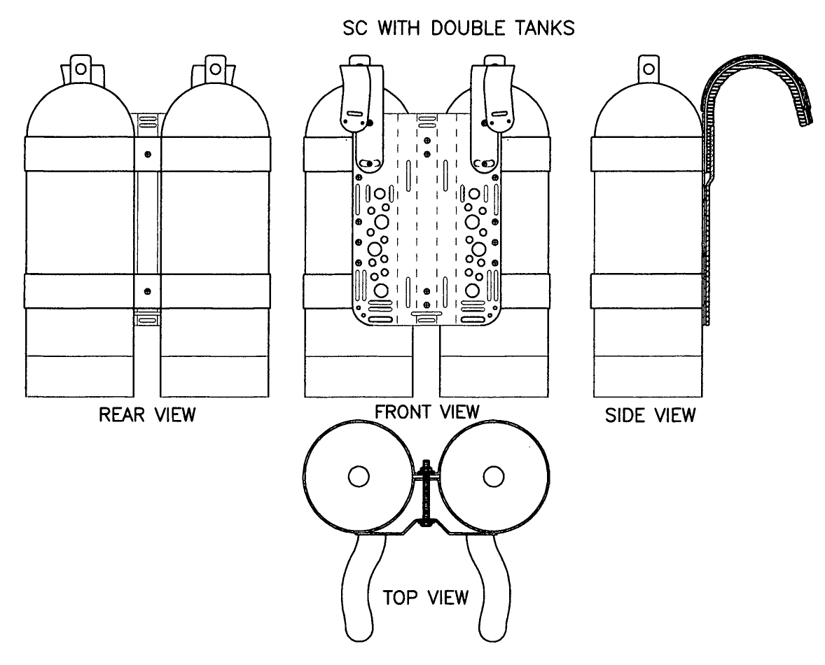

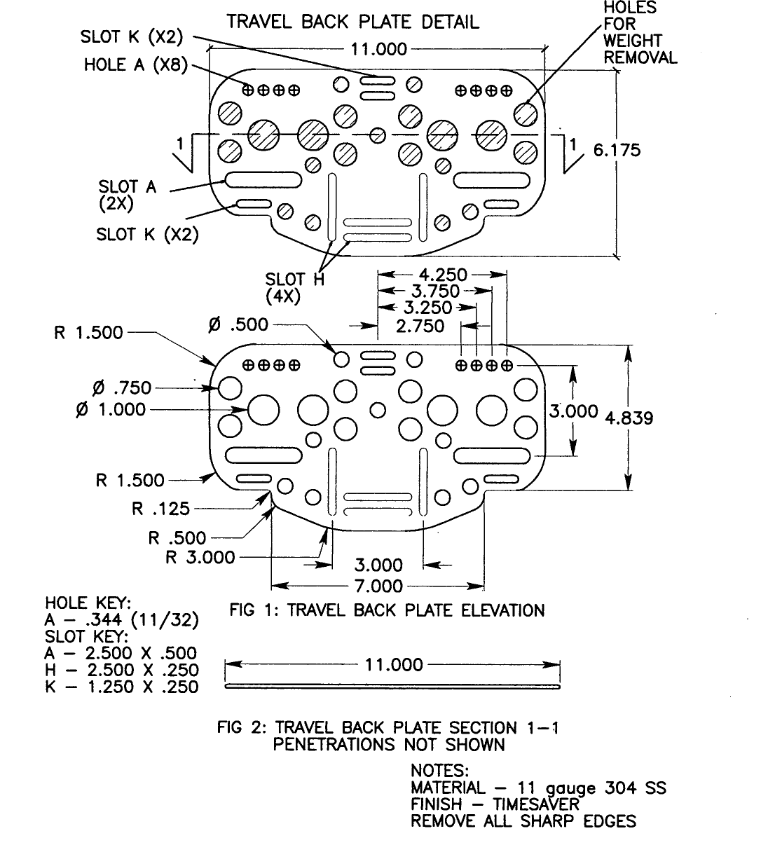

Drawing 2/27—Hook Plan (FIG. 1), Section (FIG. 2), Hook Tip Detail (FIG. 3)

FIG. 1 shows the Hook flattened view. The Hook is made from 3/16 in 304 Stainless Steel. The Hook has been ergonomically contoured in all three axes for the most comfort and adjustment. Four (4) holes and one (1) slot have been designed into the Hook to allow the attachment of the Back Plate, D-Rings and the shoulder pads. This hook can be manufactured from, but not limited to, the following materials: Stainless Steel, Plastic, Aluminum, Steel, Composites.

FIG. 2 shows the Hook side view.

FIG. 3 shows the Hook Tip Detail. This detail shows the placement of the two (2) 3/16 in holes for the D-Ring Clips (see DWG 5/27 FIG. 1) and the 1.125 in×0.25 in slot for the padding attachment.

Drawing 3/27—Range of Motion Detail

This drawing shows the range of motion that each Hook has. Each Hook can pivot on the Back Plate allowing for an overall adjustment of 9 inches (measured at the vertical quadrant of the 3.5 in radius) at the neck line.

FIG. 1 shows the maximum outward position, allowing for 12 inches of neck line.

FIG. 2 shows the mid position, allowing for 8 inches of neck line.

FIG. 3 shows the maximum inward position, allowing for 3 inches of neck line.

Drawing 4/27—Hardware Details—Sex Bolts (FIG. 1), Nylon Washer (FIG. 2), D-Ring (FIG. 3)

FIG. 1 shows the dimensional details for the Sex Bolts. These bolts (one with male threads and one with female threads) mate with each other providing a large head on both sides with a slot for adjustment.

FIG. 2 shows the specification for D-Ring. This D-Ring has a diameter of 2 in and is made from 3 mm 304 SS round stock. These D-rings are commonly used.

FIG. 3 shows the sizes and materials for the nylon washers used in the assembly.

Drawing 5/27—Hardware Details—D-Ring Clip (FIG. 1), Keepers (FIG. 2)

FIG. 1 shows the specification for the D-Ring Clip. The clip is made from 340 SS sheet metal. The metal is punched with two (2) 3/16 in holes, one on each end. The piece is then bent 180 deg and formed to capture 3 mm round stock. The two 3/16 in holes are aligned and utilized to bolt the clip to the Back Plate and the Hooks.

FIG. 2 shows the specification for the Keepers. The Keepers are punched from 304 SS. The Keepers ⅞ in high×2 ⅜ in wide. Two slots (¼ in×2 ⅛ in) are punched out that run along the long sides of the piece. The slots are equidistant from the middle and the sides of the piece. 2 in webbing is laced through this piece to hold D-rings in place on the webbing. These Keepers are commonly used.

Drawing 6/27—Shoulder Padding Assembly—Pad Bottom

This drawing shows the details of the pad bottom layer.

Drawing 7/27—Shoulder Padding Assembly—Pad Top

This drawing shows the details of the pad top layer.

Drawing 8/27—Shoulder Padding Assembly—Base Unit Assembly

This drawing shows the details of the base unit assembly.

Drawing 9/27—Shoulder Padding Assembly—Flap A

FIG. 1 shows the details of flap A.

FIG. 2 shows the details of flap E.

Drawing 10/27—Shoulder Padding Assembly—Flap B

FIG. 1 shows the details of Flap B

FIG. 2 shows the details for Flap C

FIG. 3 shows the details for Flap D

Drawing 11/27—Shoulder Padding Assembly—Base Unit and Flap A & D Assembly

This drawing shows the details of the assembly of the Base Unit to Flap A and Flap D/E.

Drawing 12/27—Shoulder Padding Assembly—Base Unit and Flap B & C Assembly

This drawing shows the details of the assembly of the Base Unit to Flap B and Flap C.

Drawing 13/27—Shoulder Padding Assembly—Section

This drawing shows the section of the shoulder pad assembly.

Drawing 14/27—Back Pad Assembly

FIG. 1 shows the details for the Back Pad assembly

This detail shows how all the parts of the back pad are joined.

FIG. 2 shows the details for the bottom tab.

The bottom tab is used to mount the back pad onto the back plate. The tab is made from 1.5 in nylon webbing and hook and loop fastener.

FIG. 3 shows the details for the top tab.

The top tab is used to mount the back pad onto the back plate. The tab is made from 1 in nylon webbing and hook and loop fastener.

Drawing 15/27—Back Pad Assembly

The drawing shows the assembly of layers A,A1 and A2.

Drawing 16/27—Back Pad Dimensions

The drawing indicates the dimensions for the back pad piece.

Drawing 17/27—Back Pad Location & Attachment

FIG. 1: Shows the location of the pads on the back plate in elevation.

FIG. 2: Shows a section of the back pads in section and the attachment method.

Drawing 18/27 Crotch Strap (FIG. 1), Waist Belt (FIG. 2).

FIG. 1 shows the specification for the crotch strap. The strap is made from 2 in heavy weight ballistic nylon webbing. One D-ring is sewn into the strap.

FIG. 2 shows the specification for the Waist belt. The belt is made from 2 inch heavy weight ballistic nylon webbing.

Drawing 19/27—Weight Pocket Details

FIG. 1: Shows the details of Flap A

FIG. 2: Shows the details of Flap B

FIG. 3: Shows the assembly of Flap A

Drawing 20/27—Weight Pocket Details

FIG. 1: Shows the details for the Pull tab

FIG. 2: Shows the details for the pocket sides.

Drawing 21/27—Weight Pocket Details

FIG. 1: Shows the details for Tab C

FIG. 2: Shows the details for Tab D

Drawing 22/27—Weight Pocket Details

FIG. 1: Shows the 1 step in pocket assembly.

FIG. 2: Shows the 2^{nd} step in the pocket assembly.

FIG. 3: Shows the 3^{rd} step in the pocket assembly.

Drawing 23/27—Weight Pocket Details

FIG. 1: Shows details for Tabs A-C.

FIG. 2: Shows the locations for Tabs A-C.

FIG. 3: Shows the side view of the pocket

Drawing 24/27—Weight System Assembly

The drawing shows the proper attachment of the weight pockets to the Back Plate and the Waist Belt.

Drawing 25/27—Assembled with single tanks

The drawing shows the attachment of a single scuba tank to the Back Plate with the use of tank straps through the single tank slots.

Drawing 26/27—Assemble with double tanks

The drawing shows the attachment of double tanks to the Back Plate with the use of dual tank bands or other alternate dual tank strapping system. The dual tanks are attached to the Back Plate with the use of bolts and wing nuts.

Drawing 27/27—Travel Back plate Detail (FIG. 1 :Travel Back Plate Elevation, FIG. 2: Travel Back Plate Section)

FIG. 1 shows the Travel Back Plate Elevation. The Back Plate is a rectangular piece of 11 Gauge (0.125) 304 Stainless Steel with 1.5 inch dia. radius corners. The plate has many punched holes and slots of different size to facilitate the attachment of the hooks, straps, pads and accessories. Additional holes have also been placed in the plate to remove some weight.

FIG. 2 shows a section view of the Back Plate.

### DETAILED DESCRIPTION OF THE INVENTION

The SC System supports SCUBA (Self Contained Underwater Breathing Apparatus) equipment with the use of semi rigid shoulder hooks and rigid back plate (see DWG 24/27) keeping the chest area clear of straps. The system allows users to don and remove SCUBA equipment with speed and ease not found in current industry products. The system is comprised of the following parts in an assembly:
Shoulder Hook
Back Plate
Travel Back Plate
Shoulder Hook Pads
Back Plate Pad
Waist Belt
Weight Pocket
Crotch Strap

Each of the parts above will be discussed in detail below.

Shoulder Hooks

The SC System consists of a new and unique support system which incorporates specially designed semi rigid hooks to replace the flexible webbing straps that are industry standard for all other commercially available SCUBA buoyancy compensating harness systems on the market today.

The current webbing type straps require the user to don his/her equipment in the same manner as a typical “backpack”. One arm is placed through the associated shoulder strap and then the other arm is placed through the second strap supporting the equipment on the users back. This method is difficult and awkward to do with SCUBA equipment and, in many cases, requires the assistance of another person to ensure that no equipment (hoses, equipment, materials, straps, etc.) becomes entangled between the straps and the user. With the use of advanced equipment (ie. a drysuit), the donning of the equipment becomes more difficult due to the added arm valves and loose material. Once the user enters the water, the typical ballistic nylon webbing harness stretches and may require additional problematic adjustment under water.

Ditching and donning the equipment while under water (which may be required if the user gets entangled in their environment) is much more complicated as the straps and equipment float or sink and move in the surge making it more likely that equipment will get tangled within and around the shoulder straps. The removal of the equipment, in or out of the water, in a typical (non emergency) situation is also a difficult task. In some designs multiple chest straps must be unbuckled prior to the removal of the shoulder straps. These buckles are difficult to locate and un-secure. The situation is compounded when the user has gloves on. The user must contort their body to remove their arm from the first strap and then perform a similar motion to remove the second. In an emergency situation, this requirement compounded with the use of exposure/thermal protection gloves prolongs the removal of the equipment when time is highly valuable. Divers have drowned due to the complexity of removing this standard type of equipment.

The hooks support the equipment on the user's shoulders without the use of interconnecting straps to the waist belt or chest straps between each other. To don the SCUBA equipment with the SC System, the user simply places their shoulders under and up into the hooks, secures the waist belt and is ready to go. This process is the same on land or in water and is highly simplified compared to a webbing based system. To remove the equipment above water, the user only needs to be seated, release the waist belt cam buckle and slide down out of the hooks. Alternately, a second person can support the equipment while standing as the user slides down and out of the hooks. The removal of the equipment in water is even easier. The user simply releases the waist belt cam buckle and pushes the hooks up and off their shoulders. This process is accomplished in a fraction of the time it takes to remove the current products.

The hooks can be manufactured from a number of materials including but not limited to: stainless steel, aluminum, plastics and composite materials.

The hook has been ergonomically contoured in all three axes for the most comfort and user size flexibility. Multiple radial curves in the X and Y axes are used to maximize the comfort of the hooks on the user (see DWG 2/27, 3/27). A contour is positioned directly above the top of the Back Plate to move the hook outward from the neck. A second contour is positioned to bring the hook back in and around the neck and position it centrally on the trapezius muscle. Finally a third contour is positioned to turn the tip of the hook outward away from the sternum of the user and onto the larger portion of the pecturalis major muscle. The hook is also contoured in the Z axis to a radius that follows anthropometric data for the 95^{th} % male user (see DWG 2/27). The radius of the hook then flattens out to reduce pressure on the clavicle and allow for larger pecturalis major muscles and breasts. These contours provide comfort to the user when supporting the SCUBA equipment in and out of the water. The hooks are offered in multiple sizes. The Small hooks are bent to a radius of 3.5 in. The medium and large sizes each increase by a 0.5 in radial increment.

One version of the hooks are made from 3/16 304 stainless steel plate. Each Hook is a mirror image of the other. They are cut from a flat plate and then rolled to accomplish the contour in the Z axis mentioned above.

Two (2) 25/64 holes are located in the hook (see DWG 2/27). These two holes are used for attachment to the Back Plate with Sex Bolts (see DWG 4/27 FIG. 1). These bolts (one with male threads and one with female threads) mate with each other providing a large head on both sides with a slot for adjustment. These parts are commonly used in the industry.

Each side of the assembly (two (2) sides total left and right) use four (4) 5/16 Nylon Washers (see DWG 4/27 FIG: 2). The Nylon washers act as bearing surfaces during adjustment of the hook. They are also used to avoid scratching and marring of the finished surfaces when the bolts are moved and tightened. These parts are commonly used in the industry.

Each hook can be positioned in one of four top adjustment holes spaced 0.5 in apart on center. The hook then pivots around this position on the back plate allowing for an overall range of adjustment of 9 inches (measured at the vertical quadrant of the 3.5 in radius) at the neck line (see DWG 3/27). Slots have been designed into the Back Plate to allow the lower Sex Bolt to slide from right to left in the slot within a given range of degrees. When the desired adjustment has been achieved, the bolts are tightened down for use.

Two (2) 3/16 holes are placed in each hook to attach the D-Rings (see DWG 2/27 FIG. 3). These D-Rings have a diameter of 2 in and are made from 3 mm 304 SS round stock (see DWG 4/27 FIG. 3). The D-rings are bent at a 10 deg. angle upward at a point 0.5 in in parallel to the flat side. These parts are commonly used in the industry.

The D-rings are attached with two clips each. The clip is made from 340 SS 16 Gauge sheet metal (see DWG 5/27 FIG. 1). The metal is punched with two (2) 3/16 holes, one on each end. The piece is then bent 180 deg and formed to capture 3 mm round stock. The two 0.220 holes are aligned and utilized to bolt the clip to the Hooks. Two (2) 3/16×0.5 in long SS pan head screws and nylon insert nuts are used to attach the clips to each Hook. These parts are commonly used in the industry.

One (1) slot has been designed into the Hook to allow the attachment of the shoulder pad. This slot is used in conjunction with the overlapping hook and loop flaps to keep the shoulder pad from slipping during use. A 1 in wide strip of hook and loop fastener (strap A see DWG 7/27) is threaded through slot A (see DWG 13/27) and is attached to flap A. Flap B is then placed on top of flap A and strap A. Placing the strap through the slot ensures the pad will not slide on the hook during use.

Back Plate

The SC System incorporates a Back Plate that works in conjunction with the SC Hooks to provide support for SCUBA equipment and adjustability for different sized users (see DWG 1/27). Commercially available back plates are designed for use with a single piece of nylon webbing. The webbing is laced through slots in the back plate to create arm straps and a waist belt from one piece of webbing. This method provides minimal comfort and time consuming adjustment process.

The Back Plate is a rectangular piece of 11 Gauge (0.125) 304 Stainless Steel with 1.5 in dia. radius corners (see DWG 1/27 FIG. 1). The plate has many punched holes and slots of different sizes to facilitate the attachment of the Hooks, Straps, Pads and accessories. The middle of the plate has a “hat channel” formed into it. This channel provides additional rigidity and a pocket for the hardware used to secure dual tanks to the plate. This pocket protects the divers back from coming in contact with the hardware. The Back Plate can be manufactured from a number of materials including but not limited to: stainless steel, aluminum, plastics and composite materials.

The SC System can be used for single SCUBA tanks, double SCUBA tanks, semi closed circuit and closed circuit re-breather systems.

The SC Back Plate provides attachment points for the SC Hooks (see DWG 1/27). These attachment points allow for adjustment of the Hooks to accommodate many different size users. The hooks attach to the plate in two places with two (2) Sex Bolts and four (4) Nylon washers. The upper attachment point for each hook acts as a pivot point (see DWG 1/27 Hole A). The lower attachment point is a curved slot that dictates the number of degrees that the Hook can pivot (see DWG 1/27 Slot A). The sex bolts are tightened once the desired adjustment is achieved. This compressing the Back Plate and the Hook which prevents the Hooks from moving during use.

Four (4) 0.391 in dia. holes (see DWG 1/27 Hole B) are provided for mounting dual tank bands (see DWG 26/27). These holes are positioned 11 in apart on center.

Four (4) 2.25 in long×0.25 in wide slots with 0.25 in dia. corners are provided in the bottom of the plate for the waist belt (see DWG 1/27 Slot C). The waist belt is laced through the slots to create an attachment that does not slip or abrade the waist belt webbing. This is a typical mounting method used in current products.

Two (2) 2.25 in long×0.25 in wide slots with 0.25 in dia. corners are provided (one left and one right) to secure a pony bottle (13-19 cuft SCUBA tank) (see DWG 01/27 Slot F). The pony bottle can be attached directly to the Back Plate with a standard tank strap. Moving the pony bottle from the main SCUBA tank (the typical location for a pony bottle to be secured) to one of these alternate locations provides better access to the pony bottle and also decreases the size profile of the diver making him/her more hydro dynamic and less susceptible to entanglement in Kelp, fishing line and guide lines in enclosed environments.

Six (6) 2.25 in long×0.25 in wide slots with 0.25 in dia. corners are provided to mount a single SCUBA tank to the plate with standard tank straps (see DWG 1/27 Slot B). This is a typical mounting method used in current products.

Four (4) 1.25 in long×0.25 in wide slots with 0.25 in dia. corners are provided for custom tailored padding on the left and right sides of the plate (see DWG 1/27 Slot G). These individual pads are mounted with hook and loop fastener strips that are laced through the slots in the Back Plate. This method of attachment ensures that the padding will not move during use.

Two (2) locations are provided for the mounting of D-Rings at the bottom left and right of the Back Plate (see DWG 1/27 Hole C). Each location includes two (2) 0.220 in holes spaced 0.670 in apart. These holes are used to mount the D-Rings with clips. The holes are aligned at a 56 deg. angle from the bottom edge. This angle allows the D-rings to be more accessible during use.

Two (2) slots are provided to mount a crotch strap (see DWG 1/27). One (1) 2.25 in long×0.25 in wide slot (Slot H) with 0.25 in dia. corners is used for a 2 in crotch strap. One (1) 1.25 in long×0.25 in wide slot (Slot J) with 0.25 in dia. corners is used for a 1 in wide crotch strap. The user can choose the size that works best for their application. This is a typical mounting method used in current products, although only one of the two sizes is usually provided.

Two (2) accessory slots are provided for miscellaneous equipment (lift bag, reels, stage bottles, etc.) (see DWG 1/27 Slot E). These (2) slots are 1.75 in long×0.375 in wide with 0.375 in dia corners. These slots are large enough to be used with clips or they can be used with webbing.

Eight (8) 0.391 in dia holes are provided for the attachment of miscellaneous equipment (stage bottles, drysuit inflation bottles, etc.) (see DWG 01/27 Hole D). These holes are positioned on each side of the plate, four (4) on each side. This is a typical mounting method used in current products.

Twenty-six (26) holes of three different sizes (1 inch, 0.75 inch, 0.5 inch) have been designed into the plate to remove excess weight (see DWG 01/27).

Travel Back Plate

The SC system has the option of using a Travel Back Plate that works in conjunction with the SC Hooks to provide support for SCUBA equipment, adjustability for different sized users and a compact size (see DWG 27/27).

This smaller plate can only be used with a single tank. A nylon webbing harness is used to attach the plate to the diver via. a waist belt. One nylon tank strap is laced through slots H (see drawing 27/27) to attach the tank to the plate. An additional tank strap is laced trough the webbing harness providing a second point of attachment to the diver. The harness also allows the diver to support the weight pockets from D-rings on the spine of the harness.

Shoulder Hook Padding

Each pad is made from four (4) types of materials as listed but not limited to: 1000 Ballistic Nylon, Ensulite expanded rubber (or other closed cell foam), hook and loop fastener and Grip Fabric #SN12000¹ (or other non slip fabric). The foam is the core of the pad. The foam is sewn to a layer of the nylon and rubber. The nylon is sandwiched between the rubber and the three components are sewn together with nylon thread. Multiple passes are made equidistant from each other perpendicular to the long axis of the piece. These stitches allow the piece to conform to the radius of the Hook. A shell is then built around the foam center encasing the piece in nylon.
¹ Grip Fabric #SN12000 is a product of Eastex Products, 36 Finnell Dr., Weymouth, Mass., 02188, (781)337-1211

Nylon flaps with hook and loop fasteners are sewn to the top of the piece. These flaps (see DWG 13/27 FLAP A & B) wrap around the Hook and serve as the primary attachment method for the pad to the Hook. A small segment of hook fastener strip is sewn to the top of the pad. This strip is placed through the Hook slot (DWG 13/27 FIG. 1) and folded back to be fastened to the flap above. This strip prevents the pad from sliding on the Hood during use. (see DWG 13/27)

Back Plate Padding

The back plate pad is made from four materials as listed but not limited to: 1000 Ballistic Nylon, Ensulite expanded rubber (or other closed sell foam), hook and loop fastener, 1 in nylon twill tape and Grip Fabric #SN12000 (or other non slip fabric). The thin pad is a composite of many layers stacked from top to bottom as follows: rubber, nylon, foam and nylon. All of these layers are sewn together around the perimeter with binding tape.

The pad attaches to the Back Plate in two places. It is attached on the bottom with one hook and loop fastener strip that is laced through slots in the plate and then attaches back to it's self (see DWG 1/27 Slot D). It is attached on the top with two hook and loop fastener strips that slide through two slots in the Back Plate and then attach to each other (see DWG 1/27 Slot G). The pad also attaches to the Shoulder Hook pad with hook and loop fastener. This helps ensure that the bottom of the hook padding does not get caught on the user when donning the equipment (see DWG 17/27).

Waist Belt

The waist belt is made from 2 inch heavy weight ballistic nylon webbing (see drawing 18/27 FIG. 2). The waist belt is a straight length of webbing with a contoured end making it easy to insert into the buckle. The waist belt is provided with a buckle and two (2) D-Rings attached with Keepers.

Weight Pockets

Drawings 19-24/27 show the construction, materials and attachment method for the weight system. Two weight pockets are constructed from 1000 ballistic nylon material, plastic stiffening sheet and hook and loop fastener. The pockets are designed to easily ditch the weights if needed in an emergency. Hook and loop fastener is used to contain the weights in the pocket. A dual overlapping flap system is utilized to safely contain the weight and prevent accidental loss. The pockets are designed to hold up to 7 lbs. of lead weight each in solid or shot form.

Current weight systems on the market are primarily waist belt mounted and do not provide for attachment of the weight system directly to the back plate. Some systems integrate the support of the shoulder strap into the mounting method for the weights. This method transfers some of the weight to the shoulders leaving the majority of the weight to be carried by the hips. These systems use the waist belt as the primary support for the weight system. This creates a stress point where the waist belt laces through the back plate. During use or removal with the current system, the weight pulls down on the waist belt and causes it to abrade where the metal back plate edge meets the webbing. This abrasion causes premature failure of the waist belt and, if left unchecked, could cause a serious hazard while diving. The weight of the SC Weight pocket is supported by the Back Plate through the use of a clip.

A clip is sewn into the back of the pocket to allow for the weight of the pocket and ballast to be supported by the back plate. A piece of 1.5 in webbing is placed through the solid ring of the clip and folded back on itself. Loop fastener is sewn to both sides of the webbing and then the assembly is sewn to the pocket on the top end only to create tab A. Loop fastener is sewn to both sides of an additional piece of 1.5 in webbing. This piece is then sewn to the weight pocket again on the top only to create tab B. Hook fastener is sewn to one side of four (4) pieces of 1.5 in webbing creating Tab C. Two of these pieces are sewn in line with tab A and B to create an interlocking sandwich of tabs (ie. Tab C, Tab A, Tab C). To install the pocket, the user simply places the waist belt in-between the back of the pocket and Tab C. The tabs are then folded over and locked in place with the hook and loop fastener and then the user attaches the clip to the hole provided in the back plate. Now the user can unzip the top of the pocket and insert the desired weight in lead shot bags or solid lead weight.

Supporting the weight system from the Back Plate takes the weight off of the users hips and makes for a more comfortable fit. This system also prevents the waist belt from sagging and makes the donning process easier.

Crotch Strap—SC-CS

Drawing 18/27 FIG. 1 shows the specification for the crotch strap. The strap is made from 2 in heavy weight ballistic nylon webbing. A 3.5 in loop is sewn into one end. This loop is used to secure the strap to the waist belt. The waist belt is passed through the loop prior to the waist belt being secured by the cam buckle. Two (2) D-Rings and two (2) Keepers are located on the strap. The strap is attached to the back plate by threading the webbing though the provided slot (see DWG 1/27 Slot H). The tail of the webbing is then laced back through a keeper to secure it in place.

1- Semi Rigid Hook type equipment support system.
What we claim as our invention is the use of semi rigid hooks to support SCUBA (self contained underwater breathing apparatus) equipment on a diver.
These hooks have been developed to replace the flexible webbing straps that are industry standard for all other commercially available scuba buoyancy compensating harness systems on the market today:
The current webbing straps require the user to don his/her equipment in the same manner as a typical “Backpack”. One arm is placed through the associated shoulder strap and then the other arm is placed through the second associated strap supporting the equipment on the users back. This method is difficult and awkward to do and requires the assistance of another person in many cases to insure that no equipment (hoses, equipment, materials, straps, etc.) becomes tangled in the straps or between the straps and the user. With the use of advanced equipment such as a drysuit, the donning of the equipment becomes more difficult due to the added arm valves and loose material associated with it. Once the user enters the water, the ballistic nylon webbing stretches and may require additional adjustment under water.
Donning the equipment while under water (which may be required if the user gets entangled in their environment) is much more complicated. The straps and equipment float or sink and move in the surge making it more likely that equipment will get tangled within/around the shoulder straps.
The removal of the equipment, in or out of the water, in a typical (non emergency) situation is also a difficult task. In some designs multiple chest straps must be un-buckled prior to removal of the shoulder straps. A user must contort there body to remove their arm from the first strap and then perform a similar motion to remove the second. In an emergency situation this requirement compounded with the use of exposure/thermal protection gloves prolongs the removal of the equipment when time is highly valuable. Divers have drowned due to the complexity of removing this standard type of equipment.
Wherein this invention comprises the use of rigid hooks which allows the user to don and ditch the equipment, in typical and emergency situations, with a speed and ease that is not provided by current commercially available products as described above. These hooks support the equipment on the user's shoulders without the use of interconnecting straps to the waist belt or chest straps between each other. To don the SCUBA equipment with the SC System, the user simply places their shoulders under and up into the hooks, secures the waist belt and is finished. This process is the same on land or in water and is highly simplified compared to a webbing based system. To remove the equipment above water, the user only needs to be seated, release the waist belt cam buckle and slide down out of the hooks. Alternately, a second person can support the equipment while standing as the user slides down and out of the hooks. The removal of the equipment in water is even easier. The user only needs to simply release the waist belt cam buckle and push the hooks up and off their shoulders. This process is accomplished in a fraction of the time that it takes to remove the current products. The hooks can be manufactured from a number of materials including but not limited to stainless steel, aluminum, plastics and composite materials.
The use of rigid hooks in the SC Buoyancy Compensating System for the support of SCUBA equipment is the basis for claim 1.
The rigid hooks provide speed and ease during the donning and removal of SCUBA equipment in typical and emergency situations.

2- Semi Rigid Hook—Ergonomic Contour
What we claim as our invention is the incorporation of an ergonomic contour into the semi rigid hooks referred to in claim 1 providing maximum comfort and user size flexibility.
Wherein the invention comprises the use of multiple radial curves in the X and Y Axes to maximize the comfort of the Hooks on the user. A contour is used directly above the top of the Back Plate to move the Hook outward from the neck, allowing for a wide range of diver neck sizes. A second contour is used to bring the Hook back in and around the neck and position it centrally on the Trapezius muscle and finally a third contour is used to turn the tip of the Hook outward away from the sternum of the user and onto the larger portion of the pecturalis major muscle. The Hook is also contoured in the Z axis to a radius that follows anthropometric data for the 95^{th} % male user. The radius of the Hook then flattens out to reduce pressure on the clavicle and allow for larger pecturalis major muscles and breasts.
The ergonomic contour of the SC Hooks is the basis for claim 2.
These contours provide comfort to the user when supporting the SCUBA equipment in and out of the water. This comfort equates into better breathing rates, less stress on the diver and more bottom time.

3- SC Hook and Back Plate connection
What we claim as our invention is the connection between the SC Hook and Back Plate system which provides a higher level of comfort than current products.
The system supports the weight of the equipment on the user's shoulders and does not apply substantial pressure on the lower back as with other webbing based systems.
Wherein the invention comprises the use of the Hooks and the Back Plate to carry the load of the equipment primarily on the shoulders (Trapezius Muscle) of the user. The focus of weight on the shoulders is accomplished though the connection to the Back Plate (see DWG 4/27 and FIG. 4). This connection does not allow the tanks to rotate into the lower back of the user as they do in webbing based systems. Reducing the load on the lower back reduces user fatigue allowing the potential for increased user awareness and safety.
The rigid connection of the Hooks to the Back Plate is the basis for claim 3. This rigid connection allows for the majority of the equipment weight to be supported by the shoulders decreasing fatigue on the lower back as compared to current webbing bases systems.

4- SC Hook Padding, Equipment and Hose Management
What we claim as our invention is the use of padding for the hooks (left and right) discussed in claim 1 to cushion the user's shoulders (clavicle and trapezius muscle) from the weight of the equipment, to minimize the amount of equipment movement on the user's shoulders through the use of a textured tacky rubber material (Grip Fabric³) and to provide methods for equipment attachment and equipment hose management.
³ Grip Fabric #SN12000 is a product of Eastex Products, 36 Finnell Dr., Weymouth, Mass., 02188, (781)337-1211
Wherein the invention comprises the use of multiple materials to form one complete Hook Pad. The Pads are constructed from four materials which include but are not limited to: 1000 Ballistic Nylon Material, Grip Fabric⁴ , Ensolite expanded rubber, hook and loop fastener, twill binding tape and nylon thread. The pad is made from a composite of these materials. Grip Fabric is placed against the user to minimize the movement of the equipment while in use. Flaps with opposite hook and loop fastening fabric wrap around the Hook and secure the pad in place. A narrow strip of hook and loop fastener is passed through a slot in the hook and is secured to the top flap with opposite hook and loop fastener. This strap prevents the pad from sliding up or down the length of the Hook. Two small flaps with opposite hook and loop fasteners are sewn approximately one third back from the front tip of the pad. The primary function of these flaps on the left Hook Pad is to capture the hoses associated with the air cell inflator/deflator valve and keep them in a predictable location range. The function of the flaps on the right Hook Pad is to capture any miscellaneous hose that the user determines is necessary for their application.
⁴ Grip Fabric #SN12000 is a product of Eastex Products, 36 Finnell Dr., Weymouth, Mass., 02188, (781)337-1211
The composite tailored Hook Padding and equipment and hose management flaps for the left and right Hooks are the basis for claim 4. These pads provide comfort for the user, keep the hooks from sliding on the user shoulders during use and function to keep essential equipment positioned during use.

5- SC Hook—Rigid D-Ring connection points for equipment.
What we claim as our invention is the incorporation of rigid connection points for D rings at the tip of each SC Hook referred to in claim 1.
Wherein the invention comprises the use of a securely mounted D-Ring to the tip of each Hook. The D-Ring is mounted to the Hook with the use of a D-ring clip and two Stainless Steel pan head screws and nylon insert nuts.
When donning SCUBA equipment with webbing a based system, the user must insert one arm though a shoulder strap and then contort their body to get the remaining arm through the other strap. Because the straps are loose webbing, any equipment that is attached to them will be pulled down by gravity. This method is difficult and awkward to do and in many cases, requires the assistance of another person to insure that no equipment attached to the shoulder straps (hoses, computers, equipment, materials, straps, etc.), is entangled in the straps or between the straps and the user. With the SC Hooks and rigid D-rings, equipment is firmly supported and is less likely of getting tangled between the shoulder strap and the user. When removing the SCUBA equipment, the items that have been attached to the webbing based system (computers, dive lights, etc.) proceed to fall as gravity pulls the equipment and loose webbing toward the ground. This may result in potential damage to the costly equipment or injury to the user.
The addition of securely mounted D-Rings to the Hooks, discussed in claim 1, to provide a stable platform for the attachment of equipment and accessories is the basis for claim 5.

6- SC Back Plate
What we claim as our invention is the integration of a Back Plate that works in conjunction with the SC Hooks referred to in claim 1 to provide support for SCUBA equipment and adjustability for different sized users.
Commercially available back plates on the market are designed for use with a single piece of nylon webbing. The webbing is laced through slots in the back plate to create arm straps and a waist belt from one piece of webbing. This method provides minimal comfort, single point failure, a difficult time consuming adjustment process and difficulty donning the apparatus.
Wherein the invention comprises of a back plate to support the SCUBA equipment in conjunction with the SC Hooks. The SC Back Plate provides attachment points for the SC Hooks. These attachment points allow for adjustment of the Hooks to accommodate many different size users. The hooks attach to the plate in two places with two (2) Sex Bolts and four (4) Nylon washers. The upper attachment point for each Hook acts as a pivot point. One of four (4) holes is selected by the user depending on size. The lower attachment point is a curved slot that dictates the number of degrees that the Hook can pivot. The sex bolts are tightened when the desired adjustment is achieved. This compresses the Back Plate and the Hook preventing the Hook from moving during use.
The Back Plate can be manufactured from a number of materials including but not limited to stainless steel, aluminum, plastics and composite materials.
The SC backplate can be used for single SCUBA tanks, double SCUBA tanks, semi closed circuit and closed circuit re-breather systems.
The SC Back Plate provides mounting and adjustment slots for the SC Hooks discussed in claim 1. This serves as the basis for claim 6.

7- SC Back Plate padding
What we claim as our invention is the design of the padding to provide comfort while allowing the user maximum access to all mounting locations and associated hardware.
Current webbing based systems either provide no padding or they provide padding that restricts access to the mounting locations and hardware. Current padding methods require the user to remove the padding by removing fasteners, opening hook and loop connections (causing unnecessary ware), by removing the waist belt (a very time consuming process) or some combination thereof.
The padding is constructed from four (4) types of materials which are but not limited to: 1000 Ballistic Nylon, Grip Fabric⁵ (or other non slip fabric), Ensolite expanded rubber (or other closed foam), twill binding tape, nylon webbing, hook and loop fastener. The materials are layered and sewn together to create the final pad. Grip Fabric is placed between the user and the plate, insuring minimal movement of the SCUBA equipment when in use.
⁵ Grip Fabric #SN12000 is a product of Eastex Products, 36 Finnell Dr., Weymouth, Mass., 02188, (781)337-1211
The pad is attached to the Back Plate with hook and loop fastener strips. Hook and loop fastener material is attached to ballistic nylon and binding tape is sewn around the edges. These strips lace through the Back Plate and attach to opposite hook and loop fasteners securing the pad in place.
The SC Back Plate Padding is a new and unique invention allowing the user comfort and protection from the rigid Back Plate while at the same time ensuring the user access to all equipment and accessory mounting locations and associated hardware without removal. This is the basis for claim 7.

8- SC Travel Back Plate
What we claim as our invention is the integration of a Travel Back Plate that works in conjunction with the SC Hooks referred to in claim 1 to provide support for SCUBA equipment, adjustability for different sized users and the compact size needed for ease of transport.

9- SC Weight Pocket System
What we claim as our invention is the integration of the SC weight pocket system with the SC Back Plate and the SC-7 Harness to provide safe secure compact no sag ballast weight mounting, quick and easy ditching of ballast weight, quick re-configuration, easy equipment donning and user comfort.
Wherein the invention consists of a weight system that is primarily supported by the back plate and not by the waist belt. The pocket is constructed from ballistic nylon, hook and loop fastener, plastic zipper, one (1) metal clip and binding tape.
The pocket is constructed with a double overlapping flap which provides redundant safety from accidental ditching a ballast weight. To release the weights you must pull up and outward on the release handle to separate flap 1 from flap 2. To separate flap 2 from the body of the pocket, you must then pull down on the release handle to allow the weight(s) to slip out of the pocket body. This redundant flap system is used in many other items on the market and is not unique to this system.
The weight of the pocket is supported by the clip and not the waist belt. This support prevents fatigue on the waist belt and makes it easier for the user to don the equipment. With the weight supported, the waist belt is not pulled toward the ground. This allows the user to easily lace the webbing through the buckle and get a tight fit. The use of hook and loop tabs instead of a permanent attachment makes the addition or removal of the weight pockets easy and does not require the user to remove buckles, D-rings and other equipment from their belt.
The attachment of the weight pocket to the back plate for support is a new and unique invention. This attachment removes the stress of the weight on the waist belt and on the hips of the user. It also makes it easier to don the equipment because the waist belt is not pulled down by the weight. The ability to remove or add a weight pocket without taking off all the equipment from the waist belt is also a new and unique feature. These benefits provide a more convenient, comfortable and safer experience. This is the basis for claim 9.
